(19) United States
(12) Patent Application Publication
(10) Pub. No.: US 2023/0202370 A1
(43) Pub. Date: Jun. 29, 2023

(54) Interchangeable Vehicle-mounted Cup Holder

(71) Applicant: Pengcheng DU, Guangdong (CN)

(72) Inventor: Pengcheng DU, Guangdong (CN)

(21) Appl. No.: 17/709,425

(22) Filed: Mar. 31, 2022

(30) Foreign Application Priority Data
Dec. 29, 2021 (CN) 202123349136.8

(51) Int. Cl. B60N 3/10

(52) U.S. Cl. CPC B60N 3/103

(57) ABSTRACT

An interchangeable vehicle-mounted cup holder disclosed in the utility model, comprises a retaining base to be set on a vehicle-mounted cup tray and a cup holder magnetically attached with the retaining base, wherein a screw cap is configured at the top of the retaining base. The screw cap is attached with an outrigger block through a quadrilateral linkage mechanism and drives the outrigger block to move through the quadrilateral linkage mechanism, so that the outrigger block is set against the cup tray and the retaining base is fixed firmly on the cup tray. The retaining base can be used to hold different cup types by changing the cup holder. This device has a simple structure and can be used to hold different cup types by changing the cup holder, which solves the problem that conventional cup holders cannot be compatible with multiple cup types.

### BACKGROUND OF THE INVENTION

The utility model relates to a field of automotive interior accessories, in particular to an interchangeable vehicle-mounted cup holder.

With the popularity of cars nowadays, drivers may be thirsty and need to drink water during prolonged driving. This requires a cup to be placed near the driver, so that it is easily accessible to the driver. The common practice is to provide a cup holder in the car to accommodate the cup.

The existing automotive cup holders are to be installed on an automotive cup tray by expanding tightly against the side wall of the cup base, but they are easy to shake. Some auto cup holders integrated with an expander can only be used for accommodating a cup with a fixed size and such incompatibility with other cup types may greatly impair the experience of customers. Therefore, it is necessary to design a novel cup holder to solve the above problems.

### BRIEF SUMMARY OF THE INVENTION

To overcome the drawbacks of the prior art, the utility model discloses an interchangeable vehicle-mounted cup holder to solve the problems of the art mentioned in the above background.

The utility model is realized through following technical solution:

An interchangeable vehicle-mounted cup holder, comprising a retaining base configured on the vehicle-mounted cup holder and a cup holder magnetically attached with the retaining base;

Wherein the said retaining base comprises a housing, a screw cap, an outrigger block and a shaft sleeve. A fixed column projecting upwards is configured at the center of housing. The screw cap is configured at the top of the housing and mounted onto the fixed column. A threaded rod is configured at the bottom of the screw cap. The shaft sleeve is set onto the threaded rod and forming a slider mechanism of the threaded rod. The outrigger block is attached with the shaft sleeve through a quadrilateral linkage mechanism. The side wall of the housing is configured with a guide hole, and the outrigger block is configured in the guide hole and is able to slide along the horizontal direction.

Preferably, the said threaded rod and the rotary knob, together with the shaft sleeve are set onto the fixed column, and inner screw threads matching with the threaded rod are configured inside the shaft sleeve.

Preferably, the said quadrilateral linkage mechanism comprises two parallel linkages, one end of each linkage is hinged to the shaft sleeve, and the other end of each linkage is hinged to the inside wall of the outrigger block.

Preferably, the said outrigger block has a hollow structure inside, and the ends of the linkages are attached with the inner wall on the hollow side of the outrigger block.

Preferably, a stopper block projecting downwards is configured on the bottom edge of the said outrigger block and is located in the housing.

Preferably, the outer wall of the said outrigger block is further configured with a slip-proof layer.

Preferably, a base is further configured at the bottom of the said housing, a circular embedded groove is configured on the top surface of the rotary knob, the base is configured in the embedded groove, and a positioning structure matching with the cup holder is configured on the base.

Preferably, magnets are configured at the top of the said base, and a suction cup matching with the magnets is configured at the bottom of the cup holder.

Preferably, a cup groove is configured at the top of the said cup holder, and bumper blocks are configured on the side wall of the cup groove.

Preferably, the quantity of the said cup holder is plural, and a plurality of cup holders are configured with cup grooves for accommodating different cup types.

Compared with the prior art, the beneficial technical effects of the utility model are as follows:

An interchangeable vehicle-mounted cup holder disclosed in the utility model, comprises a retaining base to be set on a vehicle-mounted cup tray and a cup holder magnetically attached with the retaining base, wherein a screw cap is configured at the top of the retaining base. The screw cap is attached with an outrigger block through a quadrilateral linkage mechanism and drives the outrigger block to move through the quadrilateral linkage mechanism, so that the outrigger block is set against the cup tray and the retaining base is fixed firmly on the cup tray. The retaining base can be used to hold different cup types by changing the cup holder. This device has a simple structure and can be used to hold different cup types by changing the cup holder, which solves the problem that conventional cup holders cannot be compatible with multiple cup types.

### BRIEF DESCRIPTION OF THE DRAWINGS

FIG. 1 is an exterior view of the vehicle-mounted cup holder according to the utility model;

FIG. 2 is a bottom view illustrating the structure of the cup holder according to the utility model;

FIG. 3 is a schematic view illustrating the structure of the base according to the utility model;

FIG. 4 is a schematic view illustrating the interior structure of the base according to the utility model;

FIG. 5 is an exploded view of the screw cap and the shaft sleeve according to the utility model;

FIG. 6 is a schematic view illustrating the installation of the outrigger block and the shaft sleeve according to the utility model;

FIG. 7 is a schematic view illustrating the interior structure of the outrigger block according to the utility model;

FIG. 8 is a schematic view illustrating the interior structure of the housing according to the utility model;

FIG. 9 is a partial cross-sectional view illustrating the state when the screw cap is unscrewed according to the embodiment of the utility model;

FIG. 10 is a partial cross-sectional view illustrating the state when the screw cap is screwed according to the embodiment of the utility model.

Wherein: 1. cup holder; 2. screw cap; 3. retaining base; 4. outrigger block; 5. card box; 6. bumper; 11. suction cup; 12. positioning hole; 13. positioning ring; 21. positioning column; 22. magnet; 23. base; 24. shaft sleeve; 25. threaded rod; 26. screw; 31. fixed column; 32. slip-proof layer; 33. linkage; 34. stopper block; 35. guide hole; 36. upper cover; 38. lower cover; 39. hinged support.

### DETAILED DESCRIPTION OF THE INVENTION

The utility model is further described in detail with reference to the accompanying drawings, which are given for the purposes of illustration and are not meant to limit the utility model.

It should be noted that, in the present application, the embodiment and features thereof may be combined with each other without conflict, and the utility model is further described in detail with reference to the accompanying drawings and specific embodiment.

In the embodiment of the present invention, the directional indication (such as upper, lower, left, right, front, and rear), if any, are only given for explaining the relative position relationship between or the movement of each component under a specific posture (as shown in the drawings). If the specific posture is changed, the directional indications are to be changed accordingly.

Furthermore, the phases of “the first”, “the second”, and the likes in this application are for the purposes of description only and cannot be construed as indicating or implying any relative importance or as implying the quantities of indicated technical features. Thus, a feature defined with a phase of “the first” or “the second” may explicitly or implicitly include at least one of the features.

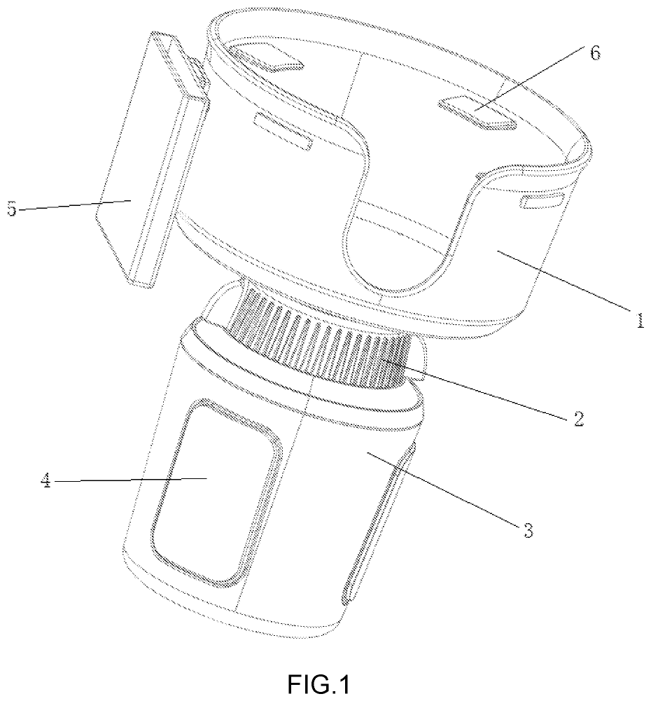

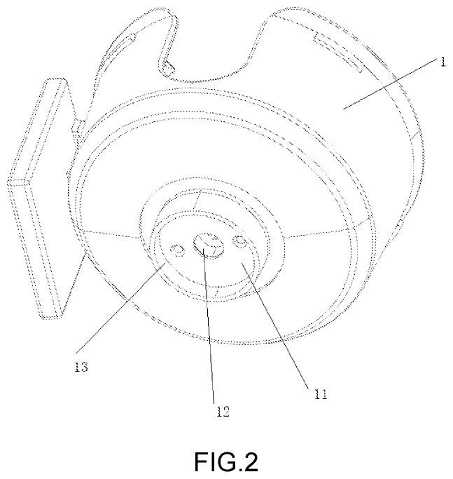

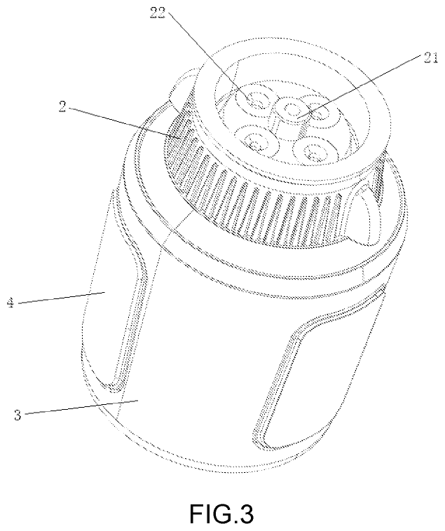

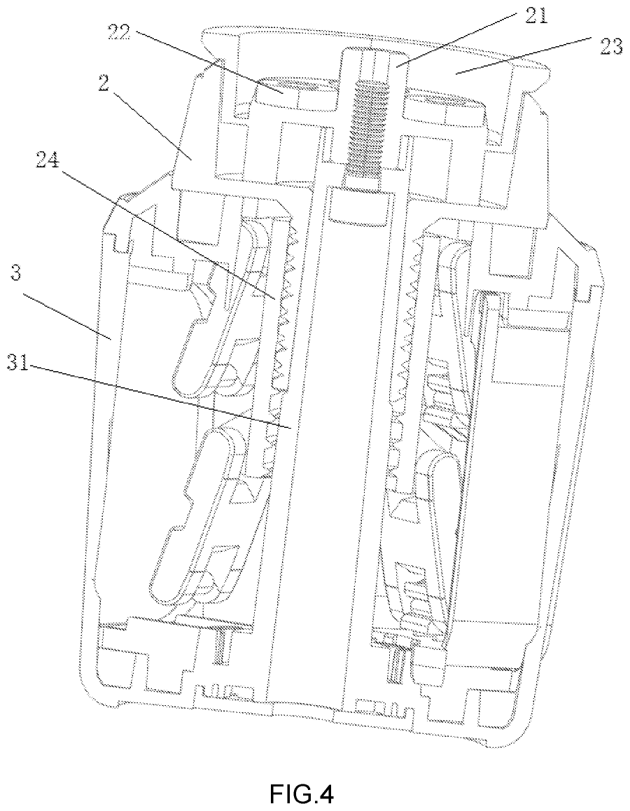

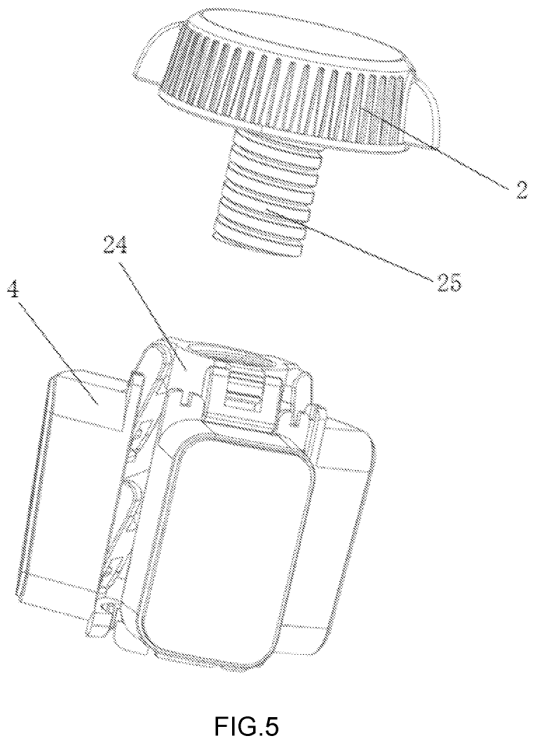

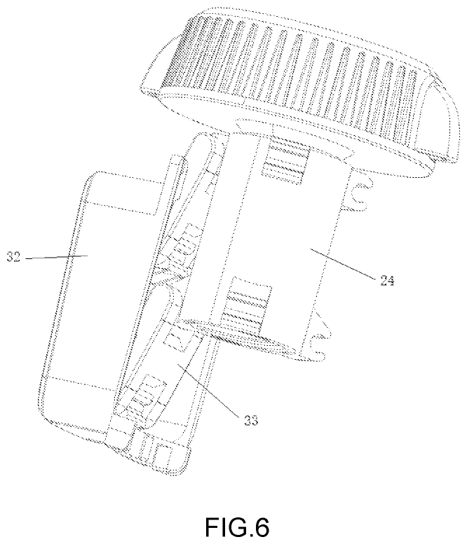

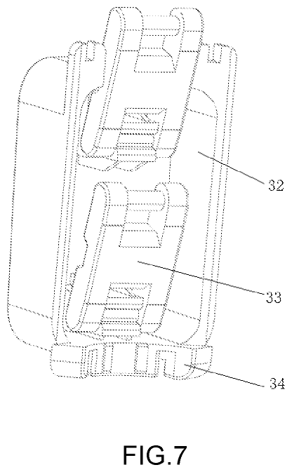

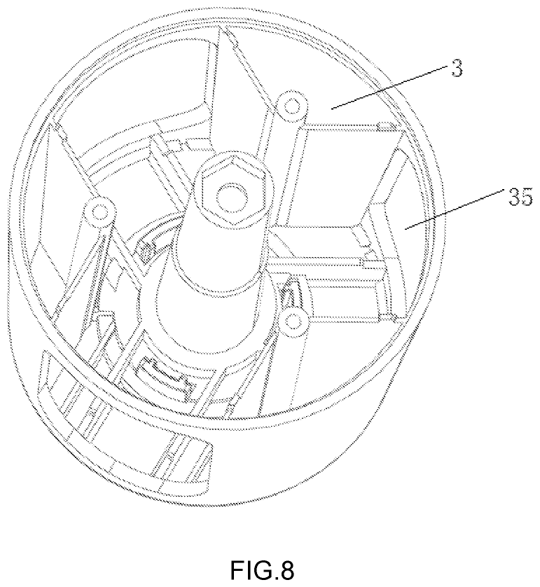

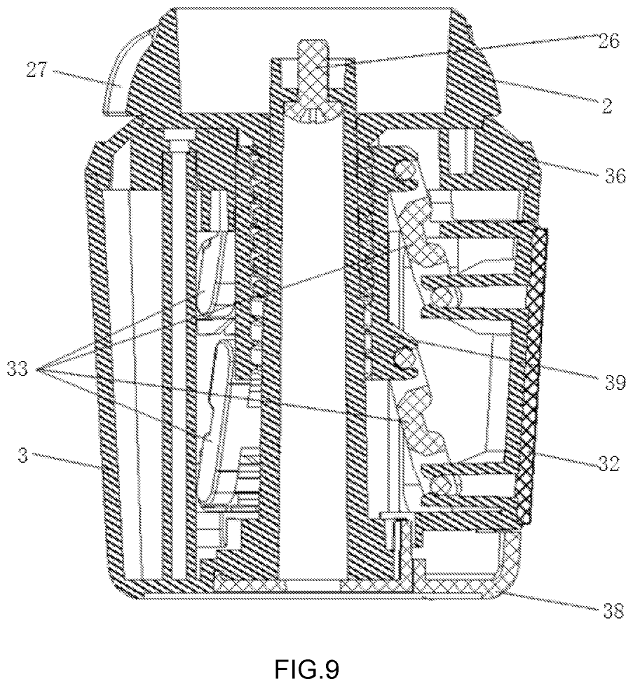

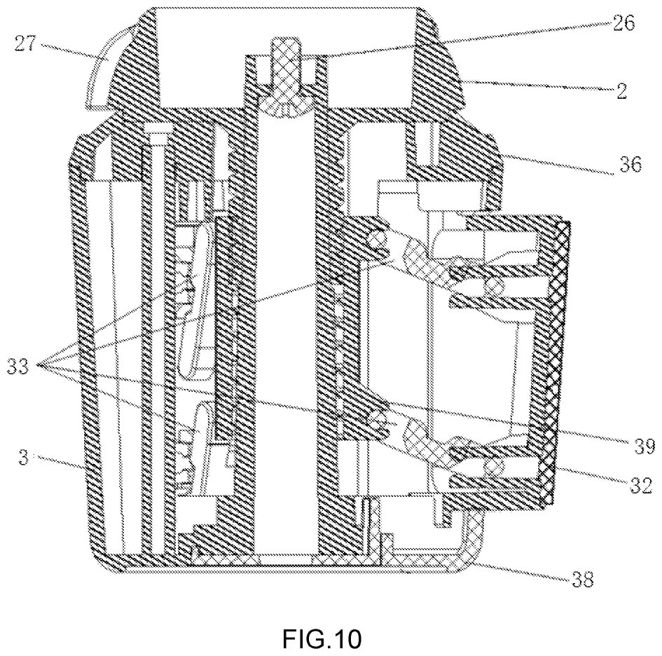

Referring to FIG. 1-10, an interchangeable vehicle-mounted cup holder comprises a retaining base 3 to be set on the vehicle-mounted cup tray and a cup holder 1 used to place a cup, wherein, the cup holder is magnetically attached with the base and located at the top of the base.

The said retaining base 3 comprises a housing, a screw cap 2, an outrigger block 4, a shaft sleeve and a quadrilateral linkage mechanism, wherein, a fixed column 31 projecting upwards is configured at the center of housing, and the screw cap 2 is configured at the top of the housing and set onto the fixed column. A threaded rod 25 is configured at the bottom of the screw cap. The shaft sleeve 24 is set onto the threaded rod forming a slider mechanism of the threaded rod. The outrigger block 4 is attached with the shaft sleeve 24 through a quadrilateral linkage mechanism. The side wall of the housing is configured with a guide hole, and the outrigger block 4 is configured in the guide hole and able to slide along the horizontal direction.

The said threaded rod is a hollow rod. The threaded rod and the rotary knob are coaxially arranged. The threaded rod and the rotary knob, together with the shaft sleeve are set onto the fixed column. Inner screw threads matching with the threaded rod are configured inside the shaft sleeve 24, and the threaded rod, when it rotates, can drive the shaft sleeve move up and down along the shaft of the threaded rod.

In this embodiment, three outrigger blocks 4 are configured. Three guide holes 35 are evenly distributed on the side wall of the housing circumferentially. The outrigger blocks 4 are assembled in the guide holes. The three outrigger blocks are respectively attached with the shaft sleeve through a quadrilateral linkage mechanism. When the shaft sleeve is driven to move downwards by the rotation of the screw cap, the shaft sleeve can push the outrigger blocks to extend the outside of the outer wall of the housing through the quadrilateral linkage mechanisms, and then the outer walls of the outrigger blocks are set against the side wall of the vehicle-mounted cup tray, so that the retaining base 3 is firmly mounted on the vehicle-mounted cup tray.

Each quadrilateral linkage mechanism comprises two parallel-arranged linkages 33. The shaft sleeve is configured with two hinged supports 39. One end of the linkage 33 is hinged to the hinged support, and the other end of the linkage is hinged to the inside wall of the outrigger block. In this embodiment, the outrigger block has a hollow structure inside, and the ends of the linkages are attached with the inner wall on the hollow side of the outrigger block, so that the quadrilateral linkage can use smaller gears, and the structure of the entire retaining base is more compact.

In this embodiment, the linkage is arranged slantways, and the upper end of the linkage is attached with the shaft sleeve. When the shaft sleeve moves downwards, the outrigger block moves to the outside of the housing and is set against the side wall of the vehicle-mounted cup holder, so that both are fixed firmly. When the shaft sleeve mores upwards, the outrigger block moves to the inside of the housing and is set against the side wall of the vehicle-mounted cup holder. The base is separated from the vehicle-mounted cup tray; a stopper block 34 projecting downwards is configured on the bottom edge of the outrigger block and is located in the housing. When the stopper block is set against the inner wall of the housing, the outrigger block reaches the maximum stroke. In order to prevent the outrigger block from being separated from the guide hole 35, the outer wall of the outrigger block is further configured with a slip-proof layer 32 to increase the friction between the vehicle-mounted cup tray.

A base 23 is further configured at the bottom of the housing. A circular embedded groove is configured on the top surface of the rotary knob. The base 23 is configured in the embedded groove. The center of the base 23 is attached with the fixed column through a screw 26 for axial positioning of the screw cap, so that the screw cap can only rotate but not perform axial movements. A downward concave positioning groove is configured at the top center of the base. A positioning column 21 projecting upwards is configured at the center of the positioning groove, and magnets 22 are further configured on the bottom surface of the positioning groove.

The said cup holder 1 comprises an open-ended cup holder body. A positioning ring 13 projecting downwards is configured at the bottom of the cup holder body. A suction cup 11 is configured with the positioning ring. A positioning hole 12 is configured at the center of the positioning ring 13; when in use. The positioning ring is assembled in the positioning groove. At the same time, the positioning column 21 is set into the positioning hole 12, and the suction cup 11 is attracted by the magnets. In this embodiment, the suction cup is a mental disc, for example, an iron disc, which is attracted by the magnets 22, so that the cup holder and the retaining base are connected firmly. This magnetism connection approach is adopted for easier installation and dismounting.

A removable card box 5 is configured on the side wall of the cup holder body for placing cards, such as highway pass cards, bank cards and ID cards. A plurality of bumper blocks are evenly distributed on the inner wall of the cup holder body circumferentially, and the ends of the bumper blocks extend to the center of the cup holder body. If a cup, whose outer diameter is smaller than the inner hole of the cup holder body, is placed in the cup holder body, the cup may shake during driving. By configuring bumper blocks made of flexible materials inside the cup holder body, when a cup is placed in the cup holder body, the outer wall of the cup is in contact with the bumper blocks, which fixes the cup firmly and prevents the cup from shaking.

In this embodiment, the bumper blocks are sheet-like structure made of silicone. When a cup is placed in the cup holder body, the horizontally-arranged silicone sheets are deformed, and the plurality of silicone sheets are used to fix the cup firmly and reduce the vibration of the vehicle during driving.

The said housing comprises a housing body, an upper cover 36 is configured at the top of the housing body. The screw cap is configured at the top of the upper cover. A lower cover 38 is configured at the bottom of the housing body, and the housing is formed by splicing a plurality of components, for easy installation of the shaft sleeve and the linkage mechanisms.

In this embodiment, a plurality of cup holders are included, the cup holder bodies of the plurality of cup holders are used for placing different cup types, and different cups can be placed on the base by changing the cup holder. The utility model discloses that the outrigger blocks are set against the inner wall of the vehicle-mounted cup tray through the linkage structure to fix the vehicle-mounted cup holder firmly. The structure is simple, and easy to install and dismount. The base of the cup holder and the cup holder are attached with each other magnetically for easier interchange of the cup holder according to the cup type.

This above description is presented to illustrate the technical concept of the utility mode and is not meant to limit the protection scope of the utility mode, and any modification made on the basis of the technical solution according to the technical concept of the present invention should be included in the protection scope of the claims of the utility model.

What is claimed is:

1. An interchangeable vehicle-mounted cup holder, characterized by comprises a retaining base (3) to be set on the vehicle-mounted cup tray and a cup holder (1) magnetically attached with the retaining base;
Wherein the said retaining base (3) comprises a housing, a screw cap (2), an outrigger block (4) and a shaft sleeve (24). A fixed column (31) projecting upwards is configured at the center of housing. The screw cap (2) is configured at the top of the housing and set onto the fixed column. A threaded rod (25) is configured at the bottom of the screw cap. The shaft sleeve (24) is set onto the threaded rod forming a slider mechanism of the threaded rod. The outrigger block (4) is attached with the shaft sleeve (24) through a quadrilateral linkage mechanism. The side wall of the housing is configured with a guide hole. The outrigger block (4) is configured in the guide hole and is able to slide along the horizontal direction.

2. An interchangeable vehicle-mounted cup holder according to claim 1, characterized in that, the said threaded rod and the rotary knob, together with the shaft sleeve are set onto the fixed column, and inner screw threads matching with the threaded rod are configured inside the shaft sleeve (24).

3. An interchangeable vehicle-mounted cup holder according to claim 1, characterized in that, the said quadrilateral linkage mechanism comprises two parallel linkages (33), one end of each linkage (33) is hinged to the shaft sleeve, and the other end of each linkage is hinged to the inside wall of the outrigger block.

4. An interchangeable vehicle-mounted cup holder according to claim 3, characterized in that, the said outrigger block has a hollow structure inside, and the ends of the linkages are attached with the inner wall on the hollow side of the outrigger block.

5. An interchangeable vehicle-mounted cup holder according to claim 1, characterized in that, a stopper block (34) projecting downwards is configured on the bottom edge of the said outrigger block and located in the housing.

6. An interchangeable vehicle-mounted cup holder according to claim 1, characterized in that, the outer wall of the said outrigger block is further configured with a slip-proof layer (32).

7. An interchangeable vehicle-mounted cup holder according to claim 1, characterized in that, a base (23) is further configured at the bottom of the said housing, a circular embedded groove is configured on the top surface of the rotary knob, the base (23) is configured in the embedded groove, and a positioning structure matching with the cup holder is configured on the base.

8. An interchangeable vehicle-mounted cup holder according to claim 1, characterized in that, magnets (22) are configured at the top of the said base, and a suction cup matching with the magnets is configured at the bottom of the cup holder.

9. An interchangeable vehicle-mounted cup holder according to claim 1, characterized in that, a cup groove is configured at the top of the said cup holder, and bumper blocks are configured on the side wall of the cup groove.

10. An interchangeable vehicle-mounted cup holder according to claim 9, characterized in that, the quantity of the said cup holder is plural, and a plurality of cup holders are configured with cup grooves for accommodating different cup types.
